(19) United States
(12) Patent Application Publication
(10) Pub. No.: US 2025/0010195 A1
(43) Pub. Date: Jan. 9, 2025

(54) VIRTUAL OBJECT CONTROL METHOD AND APPARATUS

(71) Applicant: Tencent Technology (Shenzhen) Company Limited, Shenzhen (CN)

(72) Inventor: Jiajun Wu, Shenzhen (CN)

(21) Appl. No.: 18/891,672

(22) Filed: Sep. 20, 2024

Related U.S. Application Data
(63) Continuation of application No. PCT/CN2023/123763, filed on Oct. 10, 2023.

(30) Foreign Application Priority Data
Nov. 24, 2022 (CN) 202211484689.0

(51) Int. Cl. A63F 13/57

(52) U.S. Cl. CPC A63F 13/57

(57) ABSTRACT

Disclosed herein are a virtual object control method and apparatus, a device, a medium, and a product, which relate to the field of virtual environments. This method includes: displaying a master virtual object and an interactive element in a virtual scene; controlling, in response to an attack operation on the interactive element, the master virtual object to attack the interactive element using a virtual prop; controlling, in response to an accessory switching operation, the master virtual object to switch a first prop accessory of the virtual prop to a second prop accessory; and detaching, after the first prop accessory is switched, the first prop accessory from the virtual prop, and transforming the first prop accessory into a functional prop.

### RELATED APPLICATIONS

This application is a continuation application of PCT Application PCT/CN2023/123763, filed Oct. 10, 2023, which claims priority to Chinese Patent Application No. 202211484689.0 filed on Nov. 24, 2022, each entitled “VIRTUAL OBJECT CONTROL METHOD AND APPARATUS, DEVICE, MEDIUM, AND PRODUCT”, and each which is incorporated herein by reference in its entirety.

### FIELD

Aspects of this disclosure relate to the field of virtual environments, and in particular, to a virtual object control method and apparatus, a device, a medium, and a product.

### BACKGROUND

With the improvement of culture and entertainment level, people have increasingly higher life experience and requirements for virtual world. As a way of expression of the virtual world, games have become a channel for many people to release pressure. In current game applications, to fully improve the interestingness of gameplay during the games for players, various interactive modes may be set.

In the related art, a player plays a shooting game by using a virtual firearm, and performs an attack operation on a virtual object to be attacked by consuming a virtual bullet configured in the virtual firearm, to reduce an attribute value of the virtual object.

After the player performs a reloading operation, a virtual magazine assembled with the virtual bullet in the virtual firearm may be automatically discarded, for the player to assemble the virtual firearm with a new virtual magazine and attack the virtual object. However, the gameplay of using the virtual firearm only in the shooting manner might not be diverse, which may be not only less attractive to game players, but also affects the efficiency of human-computer interaction as the players cannot continue to attack the virtual object due to the reloading operation.

### SUMMARY

Aspects herein provide a virtual object control method and apparatus, a device, a medium, and a product, which may avoid the waste of a first prop accessory after use, not only increasing the utilization of the first prop accessory, but also expanding the gameplay of games and improving the interestingness of the games. The technical solutions are as follows.

According to an aspect, a virtual object control method may be provided, performed by a computer device, the method including:
displaying a master virtual object and an interactive element in a virtual scene, the master virtual object being equipped with a virtual prop, and the virtual prop including a first prop accessory;
controlling, in response to an attack operation on the interactive element, the master virtual object to attack the interactive element using the virtual prop, the virtual prop performing an attack by consuming a prop filling element in the first prop accessory;
controlling, in response to an accessory switching operation, the master virtual object to switch the first prop accessory of the virtual prop to a second prop accessory; and
detaching, after the first prop accessory is switched, the first prop accessory from the virtual prop, and transforming the first prop accessory into a functional prop, the functional prop being configured for assisting the master virtual object to attack the interactive element.

According to another aspect, a virtual object control apparatus may be provided, including:
an object display module, configured to display a master virtual object and an interactive element in a virtual scene, the master virtual object being equipped with a virtual prop, and the virtual prop including a first prop accessory;
an operation receiving module, configured to control, in response to an attack operation on the interactive element, the master virtual object to attack the interactive element using the virtual prop, the virtual prop performing an attack by consuming a prop filling element in the first prop accessory;
an accessory switching module, configured to control, in response to an accessory switching operation, the master virtual object to switch the first prop accessory of the virtual prop to a second prop accessory; and
a prop transformation module, configured to detach, after the first prop accessory is switched, the first prop accessory from the virtual prop, and transform the first prop accessory into a functional prop, the functional prop being configured for assisting the master virtual object to attack the interactive element.

According to another aspect, a computer device may be provided. The computer device includes a processor and a memory. The memory stores at least one instruction, at least one section of a program, and a code set or an instruction set. The at least one instruction, the at least one section of the program, and the code set or the instruction set are loaded and executed by the processor to implement the virtual object control method according to any one of the aspects described herein.

According to another aspect, a computer-readable storage medium may be provided. The storage medium may store at least one instruction, at least one section of a program, and a code set or an instruction set. The at least one instruction, the at least one section of the program, and the code set or the instruction set may be loaded and executed by a processor to implement the virtual object control method according to any one of the aspects described herein.

According to another aspect, a computer program product or a computer program may be provided. The computer program product or the computer program may include computer instructions. The computer instructions may be stored in a computer-readable storage medium. A processor of a computer device may read the computer instructions from the computer-readable storage medium. The processor may execute the computer instructions to enable the computer device to perform the virtual object control method according to any one of the aspects.

The technical solutions provided in the aspects described herein have at least the following beneficial effects:

In response to the attack operation on the interactive element, the master virtual object may be controlled to attack the interactive element using the virtual prop; and in response to the accessory switching operation, the master virtual object may be controlled to switch the first prop accessory of the virtual prop to the second prop accessory, and the first prop accessory may be detached from the virtual prop and then transformed into the functional prop. In this case, after the first prop accessory is switched to the second prop accessory, the switched first prop accessory may be transformed into the functional prop that can assist the master virtual object to attack the interactive element, which avoids the waste of the first prop accessory after use, not only increasing the utilization of the first prop accessory, but also expanding the gameplay of the game and fully improving the interestingness of the game, thereby improving the efficiency of human-computer interaction.

### BRIEF DESCRIPTION OF THE DRAWINGS

FIG. 1 is a block diagram of a structure of an electronic device according to an illustrative aspect.

FIG. 2 is a block diagram of a structure of a computer system according to an illustrative aspect.

FIG. 3 is a flowchart of a virtual object control method according to an illustrative aspect.

FIG. 4 is a flowchart of a virtual object control method according to another illustrative aspect.

FIG. 5 is a schematic diagram of an interface of attacking an interactive element using a virtual prop according to an illustrative aspect.

FIG. 6 is a schematic diagram of an interface of shooting using a virtual prop to any region according to an illustrative aspect.

FIG. 7 is a schematic diagram of an interface of an accessory switching operation according to an illustrative aspect.

FIG. 8 is a schematic diagram of an interface of a functional prop in a virtual scene according to an illustrative aspect.

FIG. 9 is a schematic diagram of an interface of an explosion animation according to an illustrative aspect.

FIG. 10 is a flowchart of a virtual object control method according to still another illustrative aspect.

FIG. 11 is a flowchart of a virtual object control method corresponding to a case in which a virtual prop is implemented as a virtual firearm according to an illustrative aspect.

FIG. 12 is a flowchart of a virtual object control method according to a remaining illustrative aspect.

FIG. 13 is a schematic diagram of an interface of level selection according to an illustrative aspect.

FIG. 14 is a schematic diagram of a skill selection interface according to an illustrative aspect.

FIG. 15 is a block diagram of a structure of a virtual object control apparatus according to an illustrative aspect.

FIG. 16 is a block diagram of a structure of a terminal according to an illustrative aspect.

### DETAILED DESCRIPTION

To make the objectives, technical solutions, and advantages of the aspects described herein clearer, the following further describes the implementations in detail with reference to the accompanying drawings.

First, terms involved in the aspects described herein are briefly introduced.

Virtual world: a virtual world displayed (or provided) by an application program running on a terminal. The virtual world may be a simulated world of the real world, a semi-simulated and semi-fictional world, or a purely fictional world. The virtual world may be any one of a two-dimensional virtual world, a 2.5-dimensional virtual world, and a three-dimensional virtual world. This is not limited in this disclosure. The following aspects are described by using an example in which the virtual world may be a three-dimensional virtual world.

Virtual model: a model in a virtual world for simulating the real world. For example, the virtual model may occupy a volume in the virtual world. For example, the virtual model may include a terrain model, a building model, an animal and plant model, a virtual prop model, a virtual vehicle model, and/or a virtual character model. For example, the terrain model may include ground, mountains, rivers, water flows, rocks, steps, and the like; the building model may include houses, fences, containers, and fixtures inside buildings: tables, chairs, cabinets, beds, and the like; the animal and plant model may include trees, flowers, plants, birds, and the like; the virtual prop model may include virtual firearms, medical kits, air drops, and the like; the virtual vehicle model may include cars, ships, helicopters, and the like; and the virtual character model may include humans, animals, cartoon characters, and the like.

Virtual character: a movable object in a virtual world. The movable object may be a virtual character, a virtual animal, a cartoon character, or the like, such as a human, animal, plant, oil drum, wall, or stone displayed in the three-dimensional virtual world. In one aspect, the virtual character may be a three-dimensional model created based on the skeletal animation technique. Each virtual character has a shape and a volume in the three-dimensional virtual world, and occupies some space in the three-dimensional virtual world.

In the related art, a player plays a shooting game by using a virtual firearm, and performs an attack operation on a virtual object to be attacked by consuming a virtual bullet configured in the virtual firearm, to reduce an attribute value of the virtual object. When the player performs a reloading operation, a virtual magazine assembled with the virtual bullet in the virtual firearm may be automatically discarded, for the player to continue to attack the virtual object in a virtual scene using the virtual firearm. However, the gameplay of using the virtual firearm only in the shooting manner may be not diverse, which may be less attractive to game players.

The aspects described herein may provide a virtual object control method, which can avoid the waste of a first prop accessory after use, not only increasing the utilization of the first prop accessory, but also expanding the gameplay of games and improving the interestingness of the games. The virtual object control method obtained through training, when applied, includes at least one of various virtual scenes such as a virtual shooting scene and a virtual battle scene. The foregoing application scenarios are merely schematic examples, and the virtual object control method provided in the aspects may be further applied in other scenarios.

Before relevant data of users is collected and when relevant data of users is collected, a prompt interface and a pop-up window may be displayed or voice prompt information may be outputted. The prompt interface, pop-up window, or voice prompt information indicates that a user may be currently collecting relevant data, so that relevant operations of obtaining the relevant data of the user start to be performed only after a confirm operation performed by the user on the prompt interface or the pop-up window may be obtained. Otherwise (that is, when the confirm operation performed by the user on the prompt interface or the pop-up window may be not obtained), the relevant operations of obtaining the relevant data of the user end, that is, the relevant data of the user is not obtained. In other words, all user data may be collected with the consent and authorization of users, and the collection, use, and processing of relevant user data may need to comply with relevant laws, regulations, and standards of relevant countries and regions.

The terminal may be a desktop computer, a laptop portable computer, a mobile phone, a tablet computer, an ebook reader, a moving picture experts group audio layer III (MP3) player, a moving picture experts group audio layer IV (MP4) player, or the like. An application program that supports a virtual environment may be installed and run in the terminal, for example, an application program that supports a three-dimensional virtual environment. The application program may be any one of a virtual reality application program, a three-dimensional map program, a third-person shooting (TPS) game, a first-person shooting (FPS) game, and a multiplayer online battle arena (MOBA) game. In one aspect, the application program may be a stand-alone application program, for example, a stand-alone three-dimensional game program, or may be a network online application program.

FIG. 1 is a block diagram of a structure of an electronic device according to an illustrative aspect. The electronic device 100 may include an operating system 120 and an application program 122.

The operating system 120 may be basic software that provides secure access to computer hardware for the application program 122.

The application program 122 may be an application program that supports a virtual environment. In one aspect, the application program 122 may be an application program that supports a three-dimensional virtual environment. The application program 122 may be any one of a virtual reality application program, a three-dimensional map program, a TPS game, an FPS game, a MOBA game, and a multiplayer gunfighting survival game. The application program 122 may be a stand-alone application program, for example, a stand-alone three-dimensional game program, or may be a network online application program.

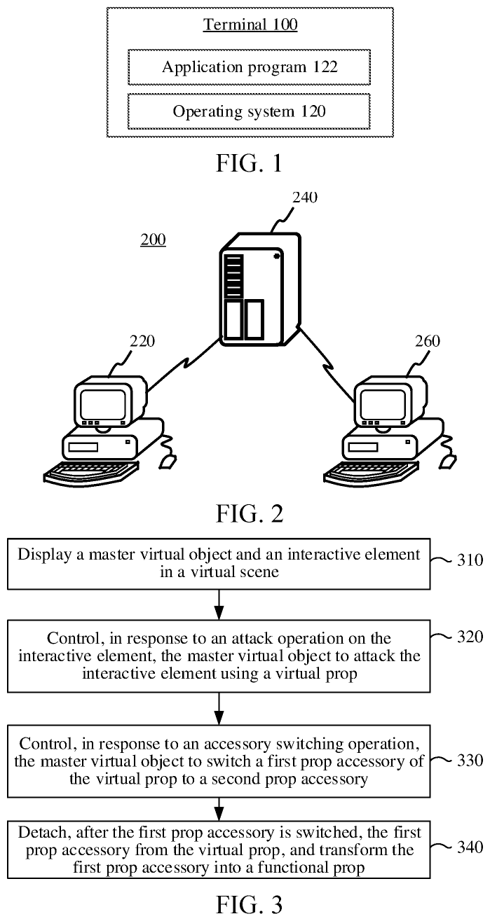

FIG. 2 is a block diagram of a structure of a computer system according to an illustrative aspect. The computer system 200 may include a first device 220, a server 240, and/or a second device 260.

An application program that supports a virtual environment may be installed and run in the first device 220. The application program may be any one of a virtual reality application program, a three-dimensional map program, a TPS game, an FPS game, a MOBA game, and a multiplayer gunfighting survival game. The first device 220 may be a device used by first user. The first user may use the first device 220 to control a first virtual object in a virtual environment to perform an activity. The activity may include, but is not limited to, at least one of body posture adjustment, crawling, walking, running, riding, jumping, driving, picking up, shooting, attacking, and throwing. For example, the first virtual object may be a first virtual character, such as a simulated character or a cartoon character.

The first device 220 may be connected to the server 240 by a wireless network or a wired network.

The server 240 may include at least one of one server, multiple servers, a cloud computing platform, and/or a virtualization center. The server 240 may be configured to provide a backend service for the application program that supports the three-dimensional virtual environment. In one aspect, the server 240 may undertake primary computing work, and the first device 220 and the second device 260 may undertake secondary computing work; or the server 240 may undertake secondary computing work, and the first device 220 and the second device 260 may undertake primary computing work; or the server 240, the first device 220, and the second device may 260 perform cooperative computing by using a distributed computing architecture.

An application program that supports a virtual environment may be installed and run in the second device 260. The application program may be any one of a virtual reality application program, a three-dimensional map program, an FPS game, a MOBA game, and a multiplayer gunfighting survival game. The second device 260 may be a device used by second user. The second user may use the second device 260 to control a second virtual object in a virtual environment to perform an activity. The activity may include, but is not limited to, at least one of body posture adjustment, crawling, walking, running, riding, jumping, driving, picking up, shooting, attacking, and throwing. For example, the second virtual object may be a second virtual character, such as a simulated character or a cartoon character.

In one aspect, the first virtual character and the second virtual character may be in the same virtual environment. In one aspect, the first virtual character and the second virtual character may belong to the same team or the same organization, or have a friend relationship or temporary communication access. In one aspect, the first virtual character and the second virtual character may belong to different teams, different organizations, or two hostile groups.

In one aspect, the application programs installed on the first device 220 and the second device 260 may be the same, or the application programs installed on the two devices may be application programs of the same type on different control system platforms. The first device 220 may be one of multiple devices, and the second device 260 may be one of multiple devices. This aspect may be described only by using the first device 220 and the second device 260 as an example. The first device 220 and the second device 260 may be of the same device type or of different device types. The device type includes at least one of a game console, a desktop computer, a smartphone, an ebook reader, an MP3 player, an MP4 player, and a laptop portable computer. The following aspects are described by using an example in which the device may be a desktop computer.

A person skilled in the art may learn that there may be more or fewer devices. For example, there may be only one device, or there may be dozens or hundreds of devices, or there may be more devices. The device quantity and device type are not limited in the aspects.

The server 240 may be implemented as a physical server, or may be implemented as a cloud server. Cloud technology refers to a hosting technology that unifies a series of resources such as hardware, software, and network in a wide area network or a local area network, to achieve data computing, storage, processing, and sharing. The cloud technology, a general term for network technology, information technology, integration technology, management platform technology, and application technology that are applied based on a business mode of cloud computing, can form a resource pool and can be used on demand, which may be flexible and convenient.

In some aspects, the method described herein may be applied in a cloud gaming scenario, so that the calculation of data logic in a game process may be completed through a cloud server, and/or a terminal may be responsible for the display of a game interface.

In some aspects, the server 240 may be implemented as a node in a blockchain system.

With reference to the brief introduction of terms and scenarios, the virtual object control method is described by using an example in which the method may be performed by a computer device, for example, the method may be applied to a terminal. As shown in FIG. 3, the method includes the following operations 310 to 340.

310. Display a master virtual object and an interactive element in a virtual scene.

In some aspects, the virtual scene may be a scene displayed by an application program running on the terminal device. The virtual scene may be a simulated environment of the real world, for example, the virtual scene may be a scene obtained through the simulation of the real world based on the construction of the real world; or may be a semi-simulated and semi-fictional scene, for example, the virtual scene includes a scene that exists in the real world (such as traffic or roads) and a fictional scene (such as Island A or Volcano B that does not exist in the real world); or may be a purely fictional scene, for example, a scene, a thing, and the like in the virtual scene have no counterpart in the real world (such as monsters and the prince of the devils).

In some aspects, the virtual scene may be at least one of a two-dimensional virtual scene, a 2.5-dimensional virtual scene, or a three-dimensional virtual scene. During the loading of the virtual scene, there may be a process of converting a two-dimensional virtual scene to a three-dimensional virtual scene, or there may be a process of converting a three-dimensional virtual scene to a two-dimensional virtual scene. For example, the virtual scene includes sky, land, ocean, and the like. The land may include environmental elements such as grassland, desert, and cities. A user may control a virtual object to move in the virtual scene.

In an optional aspect, in addition to a master virtual object controlled by a player, the virtual scene may further include an interactive element, and the interactive element may indicate a virtual object that performs virtual interaction with the master virtual object.

In one aspect, the interactive element may include at least one of virtual elements such as a virtual building, a virtual obstacle, and another virtual object.

For example, the interactive element may be a virtual object in a camp different from the master virtual object; or the interactive element may be a virtual object in a camp same as the master virtual object; or the interactive element may be a non-player character (NPC) configured by default by the system; or the interactive element may be a summoned object of a local virtual object; or the interactive element may be a virtual monster, a virtual wild monster, or the like configured by default by the system.

For example, a terminal sends a location confirmation request to a server to determine a location of an interactive element in a virtual scene, and then receives location confirmation feedback sent by the server. Location information of the interactive element in the virtual scene may be marked in the location confirmation feedback.

The master virtual object may be equipped with a virtual prop.

The master virtual object may indicate a virtual object controlled by a player. For example, the master virtual object may be a virtual character controlled by a player through an operating terminal; or the master virtual object may be a virtual pet controlled by a player through an operating terminal.

The virtual prop may be an object in a virtual environment for decorating and arranging the virtual environment or for assisting a player or providing convenience for a player. The virtual prop may be a consumable reduced with use during the game, such as a virtual firearm, a virtual bow and arrow, food, medicine, or a synthetic raw material; or may be a mission object configured for completing a storyline mission in the game, such as a letter, a skill book, or an intelligence book; or may be an equipped item that may be for assisting the virtual object to complete a mission in the game and that may be drawn, purchased, rewarded, or picked up, such as a helmet, armor, shoes, or a backpack. The virtual prop may be one of the foregoing virtual props, and the virtual prop includes a first prop accessory.

For example, the first prop accessory may be configured to assist the master virtual object to implement a prop function of the virtual prop using the virtual prop.

In one aspect, the virtual prop may be implemented as a virtual firearm, the first prop accessory may be a virtual magazine included in the virtual firearm, and the virtual magazine may be configured to assist the master virtual object to implement a shooting function corresponding to the virtual firearm using the virtual firearm; or the virtual prop may be implemented as a virtual bow and arrow, the first prop accessory may be a virtual quiver included in the virtual bow and arrow, and the virtual quiver may be configured to assist the virtual bow and arrow to implement a shooting function corresponding to the virtual bow and arrow.

320. Control, in response to an attack operation on the interactive element, the master virtual object to attack the interactive element using a virtual prop.

For example, a use operation by a player on the virtual prop may be received in the game process, to control the master virtual object to use the virtual prop; and when the use operation on the virtual prop may be performed for the interactive element in the virtual scene, the use operation may be the attack operation of attacking the interactive element using the virtual prop.

For example, the virtual prop may be implemented as a virtual firearm, a shooting operation of performing shooting using the virtual firearm by the master virtual object controlled by a player may be received, and the shooting operation may be used as the foregoing use operation; and the shooting operation by the player for the interactive element may be received to control the master virtual object to attack the interactive element using the virtual firearm, and the shooting operation may be used as the foregoing attack operation.

Alternatively, the virtual prop may be implemented as a virtual bow and arrow, a shooting operation of performing shooting using the virtual bow and arrow by the master virtual object controlled by a player may be received, and the shooting operation may be used as the foregoing use operation; and the shooting operation by the player for the interactive element may be received to control the master virtual object to attack the interactive element using the virtual bow and arrow, and the shooting operation may be used as the foregoing attack operation.

The virtual prop performs an attack by consuming a prop filling element in the first prop accessory.

The first prop accessory may be filled with a prop filling element, and the prop filling element may be configured to be consumed in the process of using the virtual prop, to implement the prop function corresponding to the virtual prop.

For example, the virtual prop may be implemented as a virtual firearm, the first prop accessory may be implemented as a virtual magazine loaded in the virtual firearm, the virtual magazine may be filled with a virtual bullet, and the virtual bullet may be the prop filling element of the virtual magazine; or the virtual prop may be implemented as a virtual bow and arrow, the first prop accessory may be implemented as a virtual quiver included in the virtual bow and arrow, the virtual quiver may be filled with a virtual arrow, and the virtual arrow may be the prop filling element of the virtual quiver.

When a player controls the master virtual object to use the virtual prop, the prop filling element in the first prop accessory included in the virtual prop may be consumed with the use of the virtual prop.

For example, the following description may be made by using an example in which the virtual prop may be implemented as a virtual firearm. The master virtual object may be controlled to use the virtual firearm for the interactive element, to implement an attack operation of attacking the interactive element by consuming a virtual bullet; or the master virtual object may be controlled to use the virtual firearm to fire a virtual bullet to any region in the virtual scene, to consume the prop filling element.

In an optional aspect, when the master virtual object may be controlled to attack the interactive element using the virtual prop, an attack animation corresponding to the attack operation may be displayed.

For example, in the game process, after receiving the attack operation performed on the interactive element using the virtual prop by the master virtual object controlled by the player, the terminal may send operation data corresponding to the attack operation to the server to request the server to send rendering data corresponding to the operation data. After receiving the rendering data sent by the server, the terminal renders the rendering data to an interface of the terminal, to display the attack animation corresponding to the attack operation.

The foregoing may be merely a schematic example. This may be not limited in the aspects.

330. Control, in response to an accessory switching operation, the master virtual object to switch a first prop accessory of the virtual prop to a second prop accessory.

In some aspects, the first prop accessory may correspondingly have element filling capacity, and the element filling capacity indicates maximum capacity of the prop filling element in the first prop accessory. For example, if the first prop accessory includes at most 50 prop filling elements, the quantity 50 may be the element filling capacity corresponding to the first prop accessory.

In some aspects, the element filling capacity may be capacity configured by default for the first prop accessory; or the element filling capacity may be capacity that changes as a player level changes.

In one aspect, the second prop accessory may be any prop accessory that can be fitted to the virtual prop. For example, the second prop accessory may be a prop accessory of the same type as the first prop accessory, for example, the first prop accessory may be a virtual magazine filled with a virtual bullet, and the second prop accessory may be another virtual magazine filled with a virtual bullet; or the second prop accessory may be a prop accessory of a different type from the first prop accessory, for example, the first prop accessory may be a virtual magazine filled with a virtual bullet, and the second prop accessory may be a special magazine filled with a virtual grenade.

For example, when the second prop accessory and the first prop accessory are prop accessories of the same type, a model and element filling capacity of the second prop accessory may be the same as those of the first prop accessory or may be different from those of the first prop accessory. For example, element filling capacity of the first prop accessory may be 50, and element filling capacity of the second prop accessory obtained through switching may be 30; or a model of a prop filling element that fills the first prop accessory may be model A, and a model of a prop filling element that fills the second prop accessory obtained through switching may be model B.

The foregoing may be merely a schematic example. This may be not limited in the aspects.

The accessory switching operation may indicate an operation of switching the first prop accessory to the second prop accessory.

In an optional aspect, a trigger operation on an accessory switching control may be used as the accessory switching operation.

For example, the accessory switching control may be displayed on a terminal display interface, and after the player performs the trigger operation on the accessory switching control, the master virtual object may be controlled to switch the first prop accessory in the virtual prop to the second prop accessory, to implement the accessory switching operation. In one aspect, the trigger operation may include various operation forms such as a click/tap operation and a long press operation.

In an optional aspect, in response to a consumption quantity of the prop filling element in the first prop accessory reaching a consumption threshold, the master virtual object may be controlled to switch the first prop accessory of the virtual prop to the second prop accessory.

The consumption threshold may be a comparative criterion of the consumption quantity of the prop filling element. In one aspect, the consumption threshold may be a value configured by default by the system; or the consumption threshold may be a value set by the player; or the consumption threshold may be a value that changes as the element filling capacity of the first prop accessory changes.

When the prop filling element in the first prop accessory is consumed, the consumption quantity of the prop filling element may be determined by determining the element filling capacity of the first prop accessory and the prop filling element remaining in the first prop accessory after the prop filling element is consumed. For example, if one prop filling element is consumed in one attack process, when a quantity of prop filling elements consumed in multiple attack processes is determined, it may be pre-determined that element filling capacity of the first prop accessory is 50 and a quantity of prop filling elements remaining in the first prop accessory after the multiple attacks is 35, then it may be determined that a quantity of consumed prop filling elements is 15, that is, the master virtual object performs 15 attacks. Alternatively, if five prop filling elements are consumed in one attack process (for example, five virtual bullets fired in a row), when a quantity of prop filling elements consumed in multiple attack processes is determined, it is pre-determined that element filling capacity of the first prop accessory is 50 and a quantity of prop filling elements remaining in the first prop accessory after the multiple attacks is 35, then it may be determined that a quantity of consumed prop filling elements may be 15, that is, the master virtual object performs three attacks.

In some aspects, the description is made by using an example in which the consumption threshold may be a value configured by default by the system. In response to the prop filling element in the first prop accessory being consumed completely, the master virtual object may be controlled to switch the first prop accessory in the virtual prop to the second prop accessory.

The prop filling element being consumed completely may be an illustrative case of the consumption quantity of the prop filling element reaching the consumption threshold. In other words, when the prop filling element in the first prop accessory may be consumed completely, the first prop accessory may be switched to the second prop accessory filled with a prop filling element.

In one aspect, the description is made by using an example in which the consumption threshold may be a value set by the player. For example, the player may set the consumption of the prop filling element to 20% as the consumption threshold; or the player may set the complete consumption of the prop filling element as the consumption threshold.

The foregoing content describes the case in which the prop filling element being consumed completely may be used as a case of the consumption quantity reaching the consumption threshold. When the prop filling element in the first prop accessory is consumed completely, the attack process cannot be performed by consuming the prop filling element in the first prop accessory, so that the first prop accessory cannot implement an attack function through the assembly process on the virtual prop. Therefore, the condition of complete consumption of the prop filling element may be used as a trigger condition of switching to the second prop accessory, which can not only avoid ineffective configuration of the first prop accessory on the virtual prop, but also switch to the second prop accessory in a more timely manner without affecting the game process, greatly improving the efficiency of the game process, enriching game experience of the player, and properly improving the efficiency of data resource transmission through a process of allocating data resources.

In some aspects, the prop filling element that fills the first prop accessory may be consumed gradually with the use of the virtual prop by the master virtual object, and an accessory switching animation may be displayed when the consumption quantity of the prop filling element in the first prop accessory reaches the consumption threshold.

The accessory switching animation may be an animation effect corresponding to the accessory switching operation. To be specific, the accessory switching animation may be an animation effect of switching the first prop accessory with the prop filling element consumed to the second prop accessory filled with the prop filling element.

In one aspect, both the first prop accessory and the second prop accessory may be virtual prop accessories that can be fitted to the virtual prop. The first prop accessory may be a virtual prop accessory with the prop filling element consumed through the foregoing consumption process. The second prop accessory may be a virtual prop accessory, other than the first prop accessory, that can be fitted to the virtual prop.

In some aspects, in response to the consumption quantity of the prop filling element in the first prop accessory reaching the consumption threshold, the first prop accessory may be switched automatically to the second prop accessory.

For example, when the consumption quantity of the prop filling element in the first prop accessory reaches the consumption threshold, by default, the system may control the master virtual object to perform an accessory switching action to switch the first prop accessory to the second prop accessory; or when the consumption quantity of the prop filling element in the first prop accessory reaches the consumption threshold and the master virtual object may be equipped with the second prop accessory, by default, the system controls the master virtual object to perform an accessory switching action to switch the first prop accessory to the second prop accessory.

In an optional aspect, in response to the consumption quantity of the prop filling element in the first prop accessory reaching the consumption threshold, a switching prompt message may be displayed.

For example, when the consumption quantity of the prop filling element in the first prop accessory reaches the consumption threshold, the switching prompt message may be displayed to prompt the player that the consumption of the prop filling element in the current first prop accessory has reached the consumption threshold.

In one aspect, in response to a received accessory switching operation, the master virtual object may be controlled to switch the first prop accessory of the virtual prop to the second prop accessory.

For example, the player knows a consumption degree of the prop filling element based on the switching prompt message, and may perform the accessory switching operation to replace the first prop accessory.

After the master virtual object performs the accessory switching action, the virtual prop accessory fitted to the virtual prop may be switched from the first prop accessory to the second prop accessory, and the player may control the master virtual object to consume the prop filling element in the second prop accessory for a subsequent game process.

After the first prop accessory is switched to the second prop accessory, with the consumption of the prop filling element that fills the second prop accessory in the game process, there may be an accessory switching operation performed on the second prop accessory, and in this case, the second prop accessory may be referred to as a first prop accessory. In other words, the accessory switching operation may be performed for multiple times in the game process. The foregoing may be merely a schematic example. This is not limited in the aspects.

340. Detach, after the first prop accessory is switched, the first prop accessory from the virtual prop, and transform the first prop accessory into a functional prop.

For example, after the master virtual object performs the accessory switching action, the first prop accessory may detach from the virtual prop and fall on a virtual surface in the virtual scene; or after the master virtual object performs the accessory switching action, the first prop accessory may separate from the virtual prop and may be accommodated in a virtual backpack corresponding to the master virtual object.

The functional prop may be configured for assisting the master virtual object to attack the interactive element. The functional prop may have a specified function and assists the master virtual object based on the specified function.

In one aspect, the functional prop and the first prop accessory have the same appearance. For example, the first prop accessory may be a virtual magazine with an appearance of a rectangular magazine shape; and after the first prop accessory may be switched and detached from the virtual prop, an accessory function of the first prop accessory for filling with the prop filling element may be transformed, and the first prop accessory may be transformed into the functional prop with the specified function, but the appearance shape may be maintained, that is, the functional prop may be a prop of the magazine shape with the specified function.

In one aspect, the functional prop and the first prop accessory may have different appearances. For example, the first prop accessory may be a virtual magazine with an appearance of a rectangular magazine shape; and after the first prop accessory is switched and detached from the virtual prop, an accessory function of the first prop accessory for filling with the prop filling element is transformed, the first prop accessory may be transformed into the functional prop with the specified function, and the appearance of the first prop accessory may be transformed, to obtain the functional prop of an appearance different from the first prop accessory. For example, the functional prop may be a prop of a sphere shape with the specified function.

The specified function may be a function corresponding to the functional prop, for implementing an assistance effect of assisting the master virtual object by performing the specified function.

In some aspects, the specified function may be a function that is configured by default by the system and/or that is associated with the functional prop; or the specified function may be a function selected by the player from at least two preset candidate functions.

For example, the specified function may be a virtual explosion function. To be specific, the functional prop may perform the specified function to assist the master virtual object to attack the interactive element through a virtual explosion attack.

For example, the specified function may be a deceleration function. To be specific, the functional prop may perform the specified function to reduce a movement speed of the interactive element within a preset range, which facilitates the master virtual object to attack the interactive element.

For example, the specified function may be a virtual smoke release function. To be specific, the functional prop may perform the specified function to assist the master virtual object to attack the interactive element through the release of virtual smoke.

For example, the specified function may be a hidden attack function. For example, after the functional prop falls on a virtual surface (for example, virtual ground) in the virtual scene, the functional prop may be hidden under the virtual surface, and when the interactive element triggers the hidden functional prop, a corresponding hidden attack effect may be implemented. For example, after the interactive element steps on the hidden functional prop, an explosion attack may be performed on the interactive element.

For example, the specified function may be a function with a gain effect. The function with the gain effect includes at least one of multiple positive functions such as a healing function, a magic point increasing function, and a level-up function. For example, the functional prop may be configured to increase attribute values and combat values of the master virtual object and other virtual objects in the same camp, to indirectly assist the master virtual object to attack the interactive element. For example, the description may be made by using an example in which the function with the gain effect may be a healing function. After the functional prop falls on a virtual surface in the virtual scene, a virtual object (the master virtual object and other virtual objects in the same camp) within a preset healing range may be healed to increase a hit point of the virtual object.

In an optional aspect, multiple candidate functions are pre-configured; and the functional prop performs, based on a selection operation on a specified function in the multiple candidate functions, the specified function.

For example, before or during the game, the player may select one candidate function from the multiple pre-configured candidate functions as the specified function corresponding to the functional prop. For example, the multiple pre-configured candidate functions may be a virtual explosion function, a virtual smoke release function, a hidden function, and the like. If the player selects the virtual explosion function as the specified function corresponding to the functional prop, the functional prop performs the virtual explosion function.

In an optional aspect, when the functional prop performs the specified function, a special effect animation of producing the specified function by the functional prop in the virtual scene may be displayed. For example, an explosion animation of producing the virtual explosion function by the functional prop in the virtual scene may be displayed.

In an optional aspect, in response to the functional prop meeting a preset condition, the functional prop may be controlled to perform the specified function in the virtual scene.

In some aspects, in response to the functional prop meeting a preset condition, the functional prop may be controlled to perform an explosion attack in the virtual scene. The explosion attack may be configured for reducing an attribute value of the interactive element within a preset range.

In some aspects, in response to the functional prop meeting a preset condition, the functional prop may be controlled to perform a deceleration attack in the virtual scene. The deceleration attack may be configured for reducing a movement speed of the interactive element within a preset range.

The preset condition indicates a preset condition for the functional prop to perform the specified function.

The foregoing content describes attack forms with different effects performed by the functional prop in the virtual scene. After the functional prop meets the preset condition, the functional prop may change an element state of the interactive element within the preset range by performing the corresponding specified function, which avoids the problem that only one accessory function of the first prop accessory may be performed. The first prop accessory may be detached from the virtual prop and transformed into the functional prop, to implement a specified function form such as an explosion attack or a deceleration attack, so that the function form of the first prop accessory can be enriched with the help of the functional prop obtained through the transformation, to perform a more targeted attack interaction process on the interactive element within the preset range, improving the diversity of the gameplay of performing an attack by the player using the virtual prop and the first prop accessory, and improving the efficiency of human-computer interaction of the player in the game process.

In one aspect, in response to a preset duration threshold based on duration of the functional prop in the virtual scene, the functional prop performs the specified function.

For example, the duration may be counted starting from the transformation of the first prop accessory into the functional prop, and the duration may be compared with the preset duration threshold. After the duration reaches the preset duration threshold, the functional prop may perform the specified function, for example, performs an explosion function or a deceleration function. In some aspects, when the duration does not reach the preset duration threshold, the functional prop might not perform the specified function.

In one aspect, in response to a collision between the functional prop and the interactive element, the functional prop performs the specified function.

For example, collision box detection may be performed on the functional prop and the interactive element in the game process. When there may be an intersection between a prop collision box corresponding to the functional prop and an object collision box corresponding to the interactive element, it may be determined that there may be a collision between the functional prop and the interactive element, and the functional prop performs the specified function in the virtual scene.

The foregoing may be merely a schematic example. This is not limited in the aspects.

In conclusion, in response to the attack operation on the interactive element, the master virtual object may be controlled to attack the interactive element using the virtual prop; and in response to the accessory switching operation, the master virtual object may be controlled to switch the first prop accessory of the virtual prop to the second prop accessory, and the first prop accessory may be detached from the virtual prop and then transformed into the functional prop. In this case, after the first prop accessory may be switched to the second prop accessory, the switched first prop accessory may be transformed into the functional prop and assists the master virtual object to attack the interactive element, which avoids the waste of the first prop accessory after use, not only increasing the utilization of the first prop accessory, but also expanding the gameplay of the game and fully improving the interestingness of the game, thereby improving the efficiency of human-computer interaction.

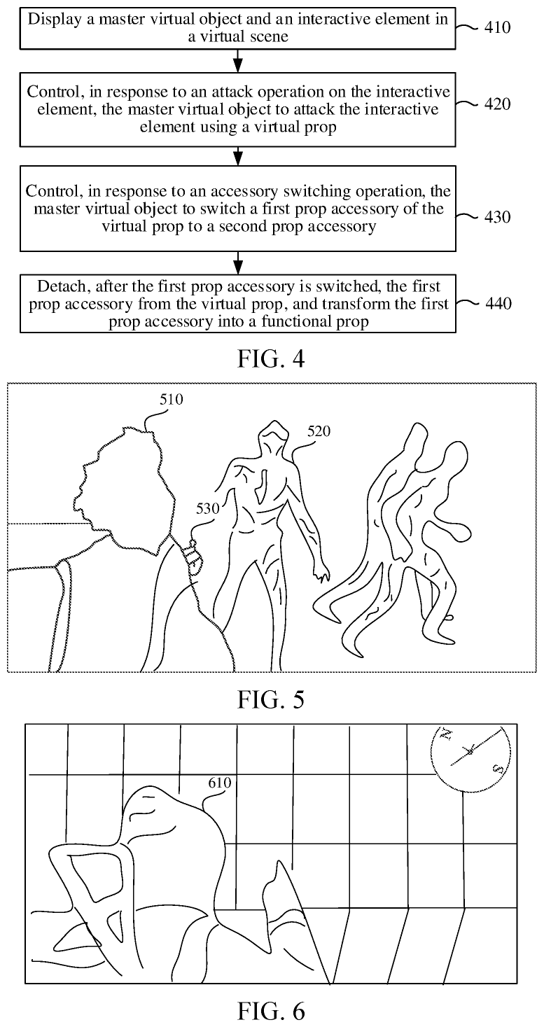

In an optional aspect, after the first prop accessory is transformed into the functional prop, when the functional prop meets a preset condition, the functional prop may be controlled to perform an explosion attack in the virtual scene. For example, as shown in FIG. 4, the example shown in FIG. 3 may alternatively be implemented as the following operations 410 to 440.

410. Display a master virtual object and an interactive element in a virtual scene.

The master virtual object may be equipped with a virtual prop, and the virtual prop includes a first prop accessory.

The master virtual object indicates a virtual object controlled by a player. For example, the master virtual object may be a virtual character controlled by a player through an operating terminal. For example, the first prop accessory may be configured to assist the master virtual object to implement a prop function of the virtual prop using the virtual prop.

In an optional aspect, in addition to a master virtual object controlled by a player, the virtual scene may further include an interactive element, and the interactive element may indicate a virtual object that performs virtual interaction with the master virtual object.

For example, a terminal sends a location confirmation request to a server to determine a location of an interactive element in a virtual scene, and then receives location confirmation feedback sent by the server. Location information of the interactive element in the virtual scene may be marked in the location confirmation feedback.

420. Control, in response to an attack operation on the interactive element, the master virtual object to attack the interactive element using a virtual prop.

For example, in the game process, the attack operation of attacking the interactive element using the virtual prop by the master virtual object controlled by the player may be received.

In the process of using the virtual prop, a prop filling element in the first prop accessory fitted to the virtual prop may be consumed, to implement the process of attacking the interactive element with the help of the prop filling element.

FIG. 5 may be a schematic diagram of an interface of a virtual scene. The virtual scene may include a master virtual object 510 controlled by a player and at least one interactive element 520. The interactive element 520 may perform an attack on the master virtual object 510 in the virtual scene. The player may control the master virtual object 510 to move in the virtual scene to avoid the attack of the interactive element 520, and may also perform an attack on the interactive element 520 using a virtual prop 530. For example, the virtual prop 530 may be implemented as a virtual firearm. The player may control the master virtual object 510 to shoot the interactive element using the virtual firearm, to cause damage to the interactive element 520.

The virtual prop may be assembled with a first prop accessory. When using the virtual prop, the master virtual object may provide power for the virtual prop through the first prop accessory, and cause attack damage to the interactive element through a prop filling element in the first prop accessory. As shown in FIG. 5, the virtual prop 530 may be implemented as a virtual firearm, the first prop accessory fitted to the virtual firearm may be a virtual magazine, and the virtual magazine may include a virtual bullet (the virtual magazine and the virtual bullet are in the virtual firearm, not shown in FIG. 5). When controlling the master virtual object 510 to shoot the interactive element using the virtual firearm, the player may cause damage to the interactive element 520 with the help of the virtual bullet that fills the virtual magazine.

For example, the virtual prop may be implemented as a virtual firearm, and the master virtual object may be controlled to perform a shooting attack on the interactive element using the virtual firearm; or the virtual prop may be implemented as a virtual bow and arrow, and the master virtual object may be controlled to perform a shooting attack on the interactive element using the virtual bow and arrow.

For example, after the master virtual object fires the prop filling element to the interactive element using the virtual prop, the prop filling element may fall on the interactive element to cause attack damage to the interactive element, for example, reduce an attribute value such as a virtual hit point or a virtual magic point of the interactive element.

As shown in FIG. 5, the master virtual object 510 attacks the interactive element 520 using the virtual firearm. As shown in FIG. 6, a virtual scene includes a master virtual object 610, and the master virtual object 610 fires a virtual bullet to any virtual region in a virtual environment using a virtual firearm.

In an optional aspect, in response to the attack operation on the interactive element, the master virtual object may be controlled to fire the prop filling element in the first prop accessory using the virtual prop to the interactive element; and in response to duration of the prop filling element remaining on the interactive element reaching preset duration, a special explosion effect of performing a virtual explosion attack on the interactive element by the prop filling element may be displayed.

For example, the prop filling element falls on the interactive element to cause delayed damage to the interactive element. For example, remaining duration of the prop filling element remaining on the interactive element may be counted. When the remaining duration reaches preset duration, the prop filling element may perform a virtual explosion attack on the interactive element, to implement delayed damage to the interactive element.

In some aspects, the prop filling element remaining on the interactive element may cause damage of a first degree to the interactive element; and when the remaining duration on the interactive element reaches the preset duration, the prop filling element may cause damage of a second degree to the interactive element through the virtual explosion attack.

For example, in the process of the prop filling element remaining on the interactive element, the prop filling element may cause erosion damage of a first degree to the interactive element, to reduce an attribute value of the interactive element by a small damage degree; and when the duration of the prop filling element remaining on the interactive element reaches the preset duration, the prop filling element may perform the virtual explosion attack on the interactive element and cause damage of a second degree to the interactive element, to reduce the attribute value of the interactive element by a large damage degree.

The foregoing content describes firing the prop filling element and displaying the special explosion effect based on the remaining duration. The prop filling element may be fired to the interactive element to make the prop filling element with the attack function on the interactive element. Then, whether to perform the explosion attack on the interactive element through the prop filling element may be determined based on the remaining duration of the prop filling element on the interactive element. In this case, instant damage can be caused to the interactive element (for example, the remaining duration may be 0 or the very short 0.001 seconds), and delayed damage can be caused to the interactive element based on the remaining duration, for example, the remaining duration may be 2 seconds, 10 seconds, or the like. The interestingness of the game may be improved while the gameplay may be enriched, and more diversified attack processes can be further performed on the interactive element, improving the effectiveness of the attack processes of players, and improving the efficiency of human-computer interaction.

In some aspects, an attack animation of attacking the interactive element by the master virtual object using the virtual prop may be displayed.

430. Control, in response to an accessory switching operation, the master virtual object to switch a first prop accessory of the virtual prop to a second prop accessory.

The accessory switching operation may indicate an operation of switching the first prop accessory to the second prop accessory.

In one aspect, a trigger operation on an accessory switching control may be used as the accessory switching operation.

In one aspect, in response to a consumption quantity of the prop filling element in the first prop accessory reaching a consumption threshold, the master virtual object may be controlled to switch the first prop accessory of the virtual prop to the second prop accessory.

In some aspects, after the first prop accessory may be switched to the second prop accessory, a virtual prop accessory fitted to the virtual prop may be the second prop accessory, and the first prop accessory separates from the virtual prop and falls around the master virtual object; or after the first prop accessory may be switched to the second prop accessory, the first prop accessory separates from the virtual prop and may be accommodated in a virtual backpack of the master virtual object.

The foregoing content describes the case in which the consumption of the prop filling element may be used as the implementation form of the accessory switching operation. After the prop filling element in the first prop accessory reaches the consumption threshold, which may be considered to meet an accessory switching condition, the terminal may automatically switch the first prop accessory to the second prop accessory, for example, switch the first prop accessory with the prop filling element consumed completely to the second prop accessory filled with the prop filling element, for a subsequent game process with the help of the second prop accessory. The accessory switching operation may be evaluated based on the consumption of the prop filling element, which can perform an accessory switching process more flexibly, avoiding the inefficiency problem of accessory replacement by players due to complete consumption of the prop filling element, thereby greatly improving the efficiency of human-computer interaction in the game process.

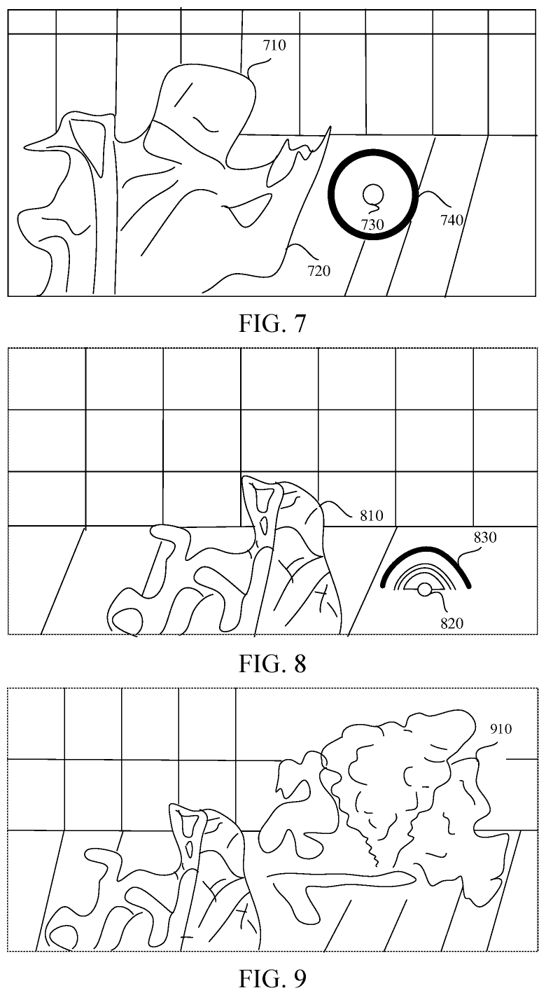

For example, FIG. 7 is a schematic diagram of performing an accessory switching action by a master virtual object. Based on an accessory switching operation, a master virtual object 710 may perform an accessory switching action on a virtual prop 720 in a virtual scene, to switch a first prop accessory 730 to a second prop accessory, and the first prop accessory 730 may separate from the virtual prop 720 and fall on a virtual surface in the virtual scene.

440. Detach, after the first prop accessory is switched, the first prop accessory from the virtual prop, and transform the first prop accessory into a functional prop.

The functional prop may be configured for assisting the master virtual object to attack the interactive element. The functional prop may have a specified function and assist the master virtual object based on the specified function. The following description may be made by using an example in which the specified function of the functional prop may be a virtual explosion function.

In some aspects, after the first prop accessory may be transformed into the functional prop, special effect prompt information may be displayed.

The special effect prompt information may indicate that the functional prop attacks the interactive element after a preset duration threshold.

For example, after the first prop accessory that separates from the virtual prop is transformed into the functional prop, the functional prop may fall around the master virtual object, and the special effect prompt information may be displayed around of the functional prop to prompt the player that the first prop accessory will perform a virtual explosion function to attack the interactive element.

In one aspect, the special effect prompt information may be presented in the form of a pattern; or the special effect prompt information may be presented in the form of text; or the special effect prompt information may be presented in the form of countdown.

In one aspect, as shown in FIG. 7, after the first prop accessory 730 is transformed into a functional prop and falls on the virtual surface, a virtual light ring 740 may be displayed. The virtual light ring 740 may be the special effect prompt information for prompting the player that the functional prop will perform a virtual explosion function in the virtual scene to attack the interactive element.

The foregoing content describes the special effect prompt information. The special effect prompt information can not only present the process of successfully transforming the first prop accessory into the functional prop to the player, but also indicate an attack state of the specified function corresponding to the functional prop to the player to prompt the player to avoid damage. In addition, it may be conducive to prompting the player to attract more interactive elements to the functional prop within a preset duration threshold, to cause targeted damage to more interactive elements, greatly improving the interestingness of the game. Moreover, it may be convenient for the player to know the game process more visually through information prompting, improving the efficiency of human-computer interaction.

In an optional aspect, a distance between the master virtual object and the functional prop and a display effect of the special effect prompt information may be in an inverse correlation.

For example, when the distance between the master virtual object and the functional prop increases, display brightness of the special effect prompt information may be weaker; or when the distance between the master virtual object and the functional prop increases, a display range of the special effect prompt information may be smaller. In one aspect, when the master virtual object may be outside an attack range of the functional prop, the display of the special effect prompt information may be canceled.

The foregoing content describes the inverse correlation between the display effect of the special effect prompt information and the distance between the master virtual object and the functional prop. The display of the inverse correlation facilitates the player to know more visually the distance relationship between the controlled master virtual object and the functional prop through the display of the special effect may prompt information, so that avoidance can be targeted to the functional prop in a preparation state for performing the function, and the game process may be more interesting without causing damage to the master virtual object, improving the efficiency of human-computer interaction.

The foregoing may be merely a schematic example. This is not limited in the aspects.

In some aspects, in response to the functional prop meeting a preset condition, the functional prop may be controlled to perform an explosion attack in the virtual scene.

The explosion attack may be configured for reducing an attribute value of the interactive element within a preset range.

The preset condition indicates a preset condition for the functional prop to perform the specified function.

In one aspect, in response to a preset duration threshold based on duration of the functional prop in the virtual scene, the functional prop may be controlled to perform the explosion attack in the virtual scene.

For example, the duration may be counted starting from the transformation of the first prop accessory into the functional prop, and the duration may be compared with the preset duration threshold. After the duration reaches the preset duration threshold, the functional prop may be controlled to perform the explosion attack in the virtual scene. In one aspect, when the duration does not reach the preset duration threshold, the functional prop does not perform the explosion attack.

In some aspects, in response to a collision between the functional prop and the interactive element, the functional prop may be controlled to perform the explosion attack in the virtual scene.

For example, collision box detection may be performed on the functional prop and the interactive element in the game process. When there is an intersection between a prop collision box corresponding to the functional prop and an object collision box corresponding to the interactive element, it may be determined that there is a collision between the functional prop and the interactive element, and the functional prop may be controlled to perform the explosion attack in the virtual scene.

The preset range may be a region range in which the specified function performed by the functional prop takes effect. For example, when the functional prop explodes in the virtual scene, the functional prop performs an explosion attack on the interactive element within the preset range, reducing an attribute value of the interactive element.

In one aspect, the attribute value of the interactive element may include at least one of various attribute values such as a virtual hit point, a virtual magic point, a virtual experience point, and a virtual skill point. For example, when the functional prop explodes in the virtual scene and performs the explosion attack on the interactive element within the preset range, reducing the virtual hit point of the interactive element; or when the functional prop explodes in the virtual scene and performs the explosion attack on the interactive element within the preset range, reducing the virtual hit point and the virtual experience point of the interactive element. Through the explosion attack of the functional prop in the virtual scene, additional damage may be caused to the interactive element within the preset range, extending the usage scenario of the functional prop, and improving the game experience of players.

For example, FIG. 8 is a schematic diagram of a functional prop in a virtual scene. A master virtual object 810 may be equipped with a virtual prop. A light ring 830 may be displayed next to a functional prop 820 to prompt the player that the functional prop 820 may be about to perform a virtual explosion function.

For example, as shown in FIG. 9, a functional prop (exploded, not shown in the figure) performs a virtual explosion in a virtual scene, resulting in an explosion animation, with virtual smoke 910 present in the explosion animation.

In some aspects, an explosion attack of a first attack degree may be performed on the interactive element based on the explosion attack performed by the functional prop in the virtual scene; and an accompanying attack of a second attack degree may be performed on the interactive element based on an explosion accompanying effect produced by the functional prop.

Attack damage of the first attack degree may be greater than attack damage of the second attack degree.

For example, the functional prop may perform a virtual explosion in the virtual scene, causing attack damage of a higher degree to the interactive element; and after the functional prop performs the virtual explosion in the virtual scene, an explosion accompanying effect (virtual smoke) may appear in the virtual scene and cause attack damage of a lower degree to the interactive element in the virtual smoke.

The foregoing content describes the explosion attack and the accompanying attack. In addition to an explosion function performed by the functional prop, an explosion accompanying effect may be produced through the explosion to cause secondary damage to the interactive element therein, so that the attack form of the functional prop may be performed to a greater extent, further improving the impact of the functional prop. Moreover, based on the difference between the first attack degree and the second attack degree, the interestingness of the game and the efficiency of human-computer interaction are improved while ensuring the reality of the game.

In an optional aspect, in response to separation duration of separation of the functional prop from the virtual prop reaching a preset duration threshold, an accessory trigger control may be displayed; and in response to receiving a trigger operation on the accessory trigger control, the functional prop may be controlled to perform an explosion attack in the virtual scene.

The accessory trigger control may be configured to control the functional prop to perform the explosion attack in the virtual scene.

For example, when the separation duration of separation of the functional prop from the virtual prop reaches the preset duration threshold, the accessory trigger control may be displayed in the virtual scene to prompt the player that the separation duration of the functional prop reaches the preset duration threshold.

Based on the trigger operation on the accessory trigger control, the functional prop may be controlled to perform the explosion attack in the virtual scene. For example, the player may control, based on the trigger operation on the accessory trigger control, the functional prop to perform the explosion attack in the virtual scene.

For example, the player may click/tap the accessory trigger control to implement the trigger operation on the accessory trigger control; or the player may long-press the accessory trigger control to implement the trigger operation on the accessory trigger control.

In an optional aspect, in response to the functional prop exploding in the virtual scene, an explosion attack animation may be displayed.

For example, in response to separation duration of separation of the functional prop from the virtual prop reaching a preset duration threshold, an explosion animation of performing an explosion attack by the functional prop in the virtual scene may be displayed.

For example, when the separation duration of separation of the functional prop from the virtual prop reaches the duration threshold configured by default by the system, the functional prop performs the explosion attack in the virtual scene, and the corresponding explosion animation may be displayed.

In conclusion, after the first prop accessory may be switched to the second prop accessory, the switched first prop accessory may be transformed into the functional prop and assist the master virtual object to attack the interactive element, which avoids the waste of the first prop accessory after use, not only increasing the utilization of the first prop accessory, but also expanding the gameplay of the game and fully improving the interestingness of the game, thereby improving the efficiency of human-computer interaction.

Disclosure herein describes that the specified function implemented by the functional prop may be the virtual explosion function. When the duration of the functional prop in the virtual scene reaches the preset duration threshold, the functional prop may be controlled to perform the explosion attack in the virtual scene, so that the functional prop can perform the corresponding virtual explosion function, which facilitates assisting the master virtual object to attack the interactive element in the virtual scene through the virtual explosion function, expanding the use range of the functional prop, greatly improving the playability of the game, and improving the usage experience of the player.

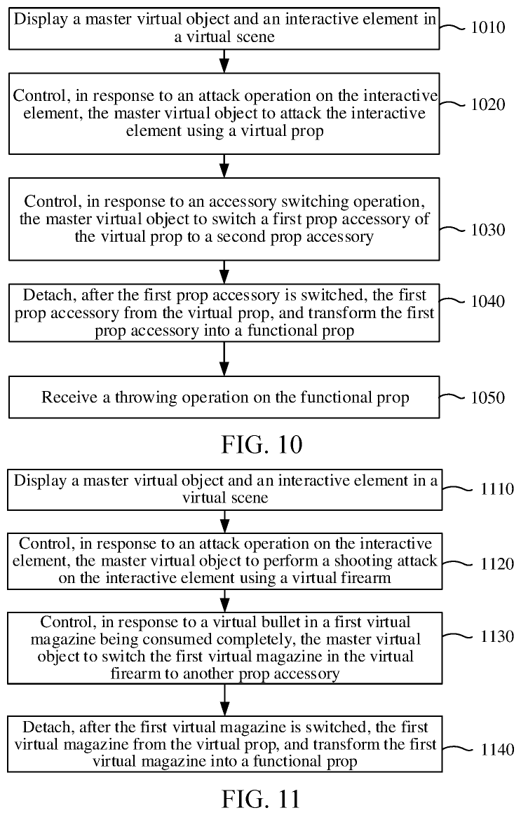

In some aspects, the functional prop may be thrown to a specified region in a throwing manner, to attack the interactive element in the specified region. For example, as shown in FIG. 10, the aspect shown in FIG. 3 may alternatively be implemented as the following operations 1010 to 1050.

1010. Display a master virtual object and an interactive element in a virtual scene.

The master virtual object may be equipped with a virtual prop, and the virtual prop includes a first prop accessory.

In one aspect, when the virtual scene is displayed in a first-person viewpoint, the master virtual object may be in the virtual scene. However, when the virtual scene is displayed, there may be a case in which a first-person viewpoint corresponding to the master virtual object may be displayed in a display interface on a terminal, and the first-person viewpoint may be used as the displayed master virtual object.

The operation 1010 has been described in the operations 310 and 410. Details are not described herein again.

1020. Control, in response to an attack operation on the interactive element, the master virtual object to attack the interactive element using a virtual prop.

The virtual prop performs an attack by consuming a prop filling element in the first prop accessory.

In some aspects, the virtual prop may be implemented as a virtual firearm, the first prop accessory corresponding to the virtual firearm may be implemented as a virtual magazine, and the prop filling element that fills the virtual magazine may be implemented as a virtual bullet. In this case, after a trigger operation on the virtual firearm may be received, the master virtual object may be controlled to attack the interactive element using the virtual firearm. In the attack process, the virtual bullet that fills the virtual magazine fitted to the virtual firearm may be consumed.

In some aspects, the virtual prop may be implemented as a virtual bow and arrow, the first prop accessory corresponding to the virtual bow and arrow may be implemented as a virtual quiver, and the prop filling element that fills the virtual quiver may be implemented as a virtual arrow. In this case, after a trigger operation on the virtual bow and arrow may be received, the master virtual object may be controlled to attack the interactive element using the virtual bow and arrow. In the attack process, the virtual arrow that fills the virtual quiver fitted to the virtual bow and arrow may be consumed.

The foregoing may be merely a schematic example. The operation 1020 has been described in the operations 320 and 420. This may be not limited in the aspects.

1030. Control, in response to an accessory switching operation, the master virtual object to switch a first prop accessory of the virtual prop to a second prop accessory.

The accessory switching operation may indicate an operation of switching the first prop accessory to the second prop accessory.

The operation 1030 has been described in the operations 330 and 430. Details are not described herein again.

1040. Detach, after the first prop accessory is switched, the first prop accessory from the virtual prop, and transform the first prop accessory into a functional prop.

The operation 1040 has been described in the operations 340 and 440. Details are not described herein again.

1050. Receive a throwing operation on the functional prop.

In one aspect, the functional prop may be a prop separated from the virtual prop, and the player can perform an independent operation on the functional prop, for example, the independent operation may be implemented as the throwing operation on the functional prop.

The throwing operation may be configured for throwing the functional prop to a specified region.

For example, the specified region may be a pre-selected region; or the specified region may be a region where the functional prop falls in the virtual scene. The specified region may be implemented as an interactive element, or may be implemented as a virtual surface, a virtual building, or the like in the virtual scene.

For example, the player triggers may prompt information that indicates the throwing operation, to implement the throwing operation on the functional prop; or the player may trigger a throwing control that appears in the virtual scene, to implement the throwing operation on the functional prop.

In some aspects, a throwing animation of throwing the functional prop to the specified region may be displayed.

For example, after the throwing operation may be received, a throwing animation of throwing the functional prop may be displayed. A start point of the functional prop in the throwing animation may be a location of the virtual prop. An end point of the functional prop in the throwing animation may be a specified region in the virtual scene.

In an optional aspect, after the functional prop may be thrown to the specified region, the functional prop may be controlled to perform a specified function in the virtual scene.

For example, after the functional prop and the specified region are in contact, the functional prop performs the specified function in the specified region.

In one aspect, after the functional prop may be thrown to the specified region, the functional prop may be controlled to perform an explosion attack in the virtual scene; or after the functional prop is thrown to the specified region, the functional prop may be controlled to perform a deceleration attack in the virtual scene.

The foregoing content describes the action form after the first prop accessory may be detached from the virtual prop and may be transformed into the functional prop. Through the throwing operation on the functional prop, the functional prop that can perform the specified function can be thrown to the specified region, so that the functional prop may implement a targeted action process of the specified function based on the specified region. For example, after the functional prop may be thrown to the specified region, the functional prop can perform an explosion attack, a deceleration attack, or the like on the interactive element within the specified range, which can not only achieve a richer attack effect with the help of the functional prop, but also enable the player to perform a more targeted attack process on the interactive element in the specified region through the throwing operation, improving the interestingness of the game and the efficiency of human-computer interaction while exerting the tactical planning ability of the player in the virtual game.

In some aspects, in response to a quantity of the prop filling element remaining in the first prop accessory being a first quantity, the first prop accessory may be transformed into a first functional prop with first attack power; or in response to a quantity of the prop filling element remaining in the first prop accessory being a second quantity, the first prop accessory may be transformed into a second functional prop with second attack power.

The first quantity may be greater than the second quantity, and the first attack degree may be greater than the second attack degree.

For example, there is still the prop filling element in the first prop accessory switched to the functional prop, and a quantity of the prop filling element in the functional prop may be determined. When the quantity of the prop filling element in the functional prop is larger, the attack degree of the specified function performed by the functional prop may be stronger. When the quantity of the prop filling element in the functional prop is smaller, the attack degree of the specified function performed by the functional prop may be weaker.

For example, the functional prop may be implemented as a virtual magazine configured in a virtual firearm. When a quantity of virtual bullets in the virtual magazine is larger, a degree of a virtual explosion function performed by the virtual magazine may be stronger. When a quantity of virtual bullets in the virtual magazine is smaller, a degree of a virtual explosion function performed by the virtual magazine may be weaker.

The foregoing content describes transforming the first prop accessory into the functional prop with different attack power based on the quantity of the prop filling element remaining in the first prop accessory. When the quantity of the prop filling element remaining in the first prop accessory may be larger, the first prop accessory can be transformed into a first functional prop with larger attack power, which can not only implement the specified function with the help of the functional prop, but also perform the stronger specified function with the help of the prop filling element. Similarly, when the quantity of the prop filling element remaining in the first prop accessory may be smaller, the first prop accessory can be transformed into a second functional prop with smaller attack power. Different attack power can improve the attack reality of the functional prop, and avoid the failure of a good attack effect due to incomplete consumption of the prop filling element, greatly improving the sense of participation of the player in the game process, and improving the efficiency of human-computer interaction.

The foregoing may be merely a schematic example. This may be not limited in the aspects.

In conclusion, after the first prop accessory may be switched to the second prop accessory, the switched first prop accessory may be transformed into the functional prop and assists the master virtual object to attack the interactive element, which may avoid the waste of the first prop accessory after use, not only increasing the utilization of the first prop accessory, but also expanding the gameplay of the game and fully improving the interestingness of the game, thereby improving the efficiency of human-computer interaction.

This aspect describes the method of using the functional prop in the throwing manner. After the first prop accessory may be transformed into the functional prop, when the throwing operation on the functional prop may be received, the functional prop may be thrown to the specified region, which facilitates implementing the specified function corresponding to the functional prop in the specified region through the throwing effect of the functional prop, and also facilitates performing the attack operation on the interactive element in the specified region, expanding the usage mode of the functional prop, and improving the interestingness of the game and the efficiency of human-computer interaction.

In an optional aspect, the virtual prop may be implemented as a virtual firearm, and the first prop accessory in the virtual prop may be implemented as a first virtual magazine in the virtual firearm. For example, as shown in FIG. 11, the aspect shown in FIG. 3 may alternatively be implemented as the following operations 1110 to 1140.

1110. Display a master virtual object and an interactive element in a virtual scene.

The master virtual object may be equipped with a virtual prop, and the virtual prop includes a first prop accessory. For example, the virtual prop equipped by the master virtual object may be a virtual firearm, and the first prop accessory included in the virtual firearm may be a first virtual magazine.

In one aspect, the first virtual magazine may correspondingly have virtual magazine capacity that indicates a maximum quantity limit of a prop filling element that fills the first virtual magazine. For example, the virtual magazine capacity of the first virtual magazine may be 60, indicating that the maximum quantity limit of the prop filling element that fills the first virtual magazine may be 60.

1120. Control, in response to an attack operation on the interactive element, the master virtual object to perform a shooting attack on the interactive element using a virtual firearm.

A virtual bullet in the virtual magazine may be consumed in the shooting attack process.

In response to the attack operation on the interactive element, the master virtual object may be controlled to attack the interactive element using the virtual prop.

For example, the player may control the master virtual object to perform the shooting attack using the virtual firearm, and consume the virtual bullet in the first virtual magazine during the shooting attack. For example, the player may perform the shooting attack using the virtual firearm on the interactive element in the virtual scene, and consume the virtual bullet in the shooting attack process.

1130. Control, in response to a virtual bullet in a virtual magazine being consumed completely, the master virtual object to switch the first virtual magazine in the virtual firearm to another prop accessory.

For example, when the virtual bullet in the first virtual magazine may be consumed completely, the virtual magazine may be switched automatically to another prop accessory. For example, in the process of using the virtual firearm by the master virtual object, the virtual bullet in the first virtual magazine fitted to the virtual firearm may be consumed. If the virtual bullet in the virtual magazine is consumed completely, that is, there may be no virtual bullet in the first virtual magazine, the master virtual object automatically switches the first virtual magazine to another prop accessory, for example, switches the first virtual magazine to a second virtual magazine (a virtual magazine other than the first virtual magazine), or switches the first virtual magazine to another accessory. For example, the second virtual magazine may be filled partially with virtual bullets; or the second virtual magazine may be filled up with virtual bullets.

1140. Detach, after the first virtual magazine is switched, the first virtual magazine from the virtual prop, and transform the first virtual magazine into a functional prop.

In one aspect, the functional prop performs a specified function in the virtual scene. The specified function may be a function corresponding to the first virtual magazine.

For example, the specified function may be a function that may be configured by default by the system and that may be associated with the first virtual magazine; or the specified function may be a function selected by the player from at least two preset candidate functions.

The foregoing may be merely a schematic example. The virtual prop may be implemented as another virtual prop such as a virtual attack or a virtual medicine bottle. Correspondingly, the first prop accessory corresponding to the virtual prop and the prop filling element that fills the first prop accessory are implemented as corresponding forms. This may be not limited in the aspects.

In conclusion, after the first prop accessory may be switched to the second prop accessory, the switched first prop accessory may be transformed into the functional prop and assist the master virtual object to attack the interactive element, which may avoid the waste of the first prop accessory after use, not only increasing the utilization of the first prop accessory, but also expanding the gameplay of the game and fully improving the interestingness of the game, thereby improving the efficiency of human-computer interaction.

This aspect describes the virtual object control method corresponding to a case in which the virtual prop may be implemented as the virtual firearm. When the virtual magazine in the virtual firearm is switched and transformed into the functional prop, and the functional prop may perform the specified function in the virtual scene, the used virtual magazine may be fully utilized when the interactive element may be attacked with the help of the prop filling element that fills the virtual magazine, and the consumed first virtual magazine can also produce an attack effect in the virtual scene through the specified function performed in the virtual scene by the functional prop obtained through the transformation, expanding the gameplay of the game and fully improving the interestingness of the game, thereby improving the efficiency of human-computer interaction.

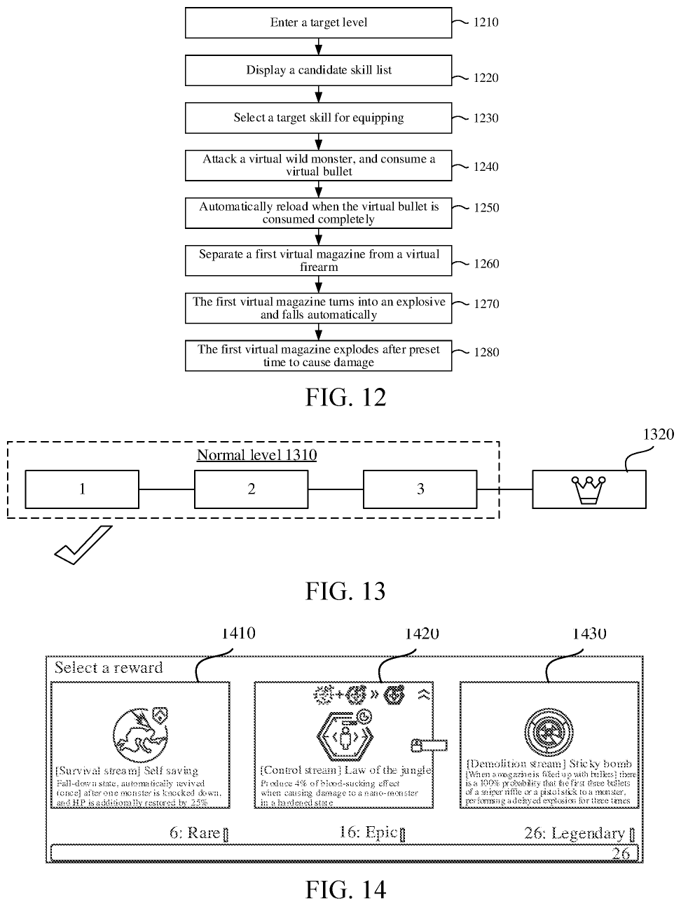

In some aspects, the virtual object control method may be applied to a shooting game, which may be referred to as the gameplay of turning an empty magazine into an explosive in the shooting game. For example, as shown in FIG. 12, the aspect shown in FIG. 3 may alternatively be implemented as the following operations 1210 to 1280.

1210. Enter a target level.

In one aspect, based on a selection operation by the player on a level in the game, the target level selected by the player may be entered.

For example, FIG. 13 is a schematic diagram of level selection, which may include three normal levels 1310 and one ultimate level 1320. The three normal levels 1310 may include a level 1, a level 2, and a level 3.

In the three normal levels 1310, the master virtual object controlled by the player may perform a solo challenge; or the master virtual object controlled by the player teams up with at least one virtual object to perform a challenge, for example, the master virtual object may team up with two matched virtual objects for the normal levels 1310.

In some aspects, the three normal levels 1310 may have fixed level duration. If the master virtual object performs a solo challenge, when the master virtual object may be eliminated, the game may be over (GameOver); or when the master virtual object is not eliminated within the level duration, the challenge may be successful. Alternatively, if the master virtual object teams up with at least one virtual object to perform a challenge, when all the master virtual object and the virtual object are eliminated, the game may be over; or when there is at least one virtual object that is not eliminated within the level duration, the challenge may be successful.

For example, the normal levels 1310 may be a phase in which the master virtual object performs farming, which may be commonly known as a farm phase; and a build may be constructed in the farm phase.

In one aspect, after passing the first three normal levels 1310, the master virtual object may choose to enter the ultimate level 1320. For example, the first three normal levels 1310 may be progressive levels, that is, when the master virtual object passes the level 1, the level 2 may be opened; or the first three normal levels 1310 may be open levels, that is, the player may select any level to play the game. For example, as shown in FIG. 13, the player may select the level 1 as the target level to perform a game battle process of the level 1.

1220. Display a candidate skill list.

For example, in response to the player entering the target level, the candidate skill selection list may be displayed.

In an optional aspect, a skill selection interface may be displayed. The skill selection interface includes at least two candidate skills.

As shown in FIG. 13, in the three normal levels 1310, a candidate skill (Super Perk) may be randomly obtained at a specific time pace in the level, and a build may be constructed.

For example, FIG. 14 shows a candidate skill selection list including three candidate skills: a survival stream skill 1410, a control stream skill 1420, and a demolition stream skill 1430. The survival stream skill 1410 may indicate that the master virtual object that is controlled by the player and that is in a fall-down state is automatically revived once after one monster is knocked down, and an attribute value is additionally restored. The control stream skill 1420 may indicate that the master virtual object controlled by the player produces an additional blood-sucking effect when causing damage to a nano-monster (the interactive element to be attacked) in a hardened state. The demolition stream skill 1430 may indicate that when a magazine (clip) of the master virtual object controlled by the player may be filled up with bullets, there may be a 100% probability that the first three bullets of a virtual sniper rifle stick to a nano-monster, performing a three-second delayed explosion.

1230. Select a target skill for equipping.

In one aspect, in response to a selection instruction of the player, the target skill selected from the list may be equipped to a virtual character controlled by the player, for the virtual character to use the target skill.

In an optional aspect, a selection operation on the target skill in the at least two candidate skills may be received.

The selection operation may be configured for displaying the configuration of the target skill for the virtual prop equipped by the master virtual object, and the target skill may be configured for assisting the master virtual object to perform a prop function of the virtual prop.

For example, as shown in FIG. 14, based on a selection operation on the demolition stream skill 1430 by the player, the demolition stream skill 1430 may be used as the target skill, and the demolition stream skill 1430 may be configured for the virtual prop, so that the master virtual object performs a trigger operation on the virtual prop.

The foregoing content describes the selection operation on the target skill in the skill selection interface. Multiple candidate skills are displayed in the skill selection interface to provide a more diversified selection process for the player. Then, the target skill may be determined based on the selection from the multiple candidate skills. The target skill can assist the master virtual object to perform the prop function of the virtual prop in a more targeted manner, thereby implementing a more diversified game process and enriching a game presentation effect with the combination of the independent choice of the player and the configuration effect of the game.

1240. Attack a virtual wild monster, and consume a virtual bullet.

For example, the virtual prop equipped by the master virtual object may be a virtual firearm, the virtual firearm may be assembled with a first virtual magazine, the first virtual magazine may be filled with a virtual bullet, and the player may control the master virtual object to attack a virtual wild monster (for example, the foregoing nano-monster) in the virtual scene by consuming the virtual bullet, causing attack damage to the virtual wild monster, and reducing an attribute value of the virtual wild monster.

1250. Automatically reload when the virtual bullet may be consumed completely.

For example, when the virtual bullet in the first virtual magazine is consumed completely, the master virtual object may be automatically controlled to switch the first virtual magazine to a second virtual magazine, achieving an automatic reloading effect.

1260. Separate the first virtual magazine from the virtual firearm.

For example, in the process of switching the first virtual magazine to the second virtual magazine, the first virtual magazine may be separated from the virtual firearm.

1270. The first virtual magazine turns into an explosive and falls automatically.

For example, the first virtual magazine may fall on a virtual surface in the virtual scene after being separated from the virtual firearm, implementing the automatic falling process. In one aspect, after being separated from the virtual firearm, the first virtual magazine may automatically turn into the explosive that can implement a virtual explosion function.

1280. The first virtual magazine explodes after preset time to cause damage.

For example, the first virtual magazine may perform the virtual explosion function after the preset time after being separated from the virtual firearm, causing damage to the virtual wild monster in the virtual scene; or the first virtual magazine may perform the virtual explosion function after the preset time after falling on the virtual surface, causing damage to the virtual wild monster in the virtual scene.

The foregoing may be merely a schematic example. This may be not limited in the aspects.

In conclusion, after the first prop accessory may be switched to the second prop accessory, the switched first prop accessory may be transformed into the functional prop and assists the master virtual object to attack the interactive element, which avoids the waste of the first prop accessory after use, not only increasing the utilization of the first prop accessory, but also expanding the gameplay of the game and fully improving the interestingness of the game, thereby improving the efficiency of human-computer interaction.

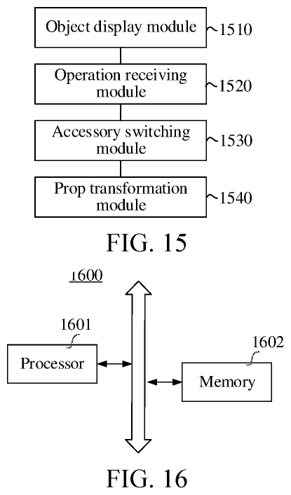

FIG. 15 is a block diagram of a structure of a virtual object control apparatus according to an illustrative aspect. As shown in FIG. 15, the apparatus includes the following parts:
an object display module 1510, that may be configured to display a master virtual object and an interactive element in a virtual scene, the master virtual object being equipped with a virtual prop, and the virtual prop including a first prop accessory;
an operation receiving module 1520, that may be configured to control, in response to an attack operation on the interactive element, the master virtual object to attack the interactive element using the virtual prop, the virtual prop performing an attack by consuming a prop filling element in the first prop accessory;
an accessory switching module 1530, that may be configured to control, in response to an accessory switching operation, the master virtual object to switch the first prop accessory of the virtual prop to a second prop accessory; and
a prop transformation module 1540, that may be configured to detach, after the first prop accessory is switched, the first prop accessory from the virtual prop, and transform the first prop accessory into a functional prop, the functional prop being configured for assisting the master virtual object to attack the interactive element.

In some aspects, the prop transformation module 1540 may be further configured to control, in response to the functional prop meeting a preset condition, the functional prop to perform an explosion attack in the virtual scene, the explosion attack being configured for reducing an attribute value of the interactive element within a preset range.

In some aspects, the prop transformation module 1540 may be further configured to control, in response to the functional prop meeting a preset condition, the functional prop to perform a deceleration attack in the virtual scene, the deceleration attack being configured for reducing a movement speed of the interactive element within a preset range.

In some aspects, the prop transformation module 1540 may be further configured to control, in response to a consumption quantity of the prop filling element in the first prop accessory reaching a consumption threshold, the master virtual object to switch the first prop accessory of the virtual prop to the second prop accessory.

In some aspects, the prop transformation module 1540 may be further configured to control, in response to the prop filling element in the first prop accessory being consumed completely, the master virtual object to switch the first prop accessory in the virtual prop to the second prop accessory.

In some aspects, the prop transformation module 1540 may be further configured to receive a throwing operation on the functional prop, and control the master virtual object to throw the virtual prop to a specified region.

In some aspects, the prop transformation module 1540 may be further configured to transform, in response to a quantity of the prop filling element remaining in the first prop accessory being a first quantity, the first prop accessory into a first functional prop with first attack power; or transform, in response to a quantity of the prop filling element remaining in the first prop accessory being a second quantity, the first prop accessory into a second functional prop with second attack power, the first quantity being greater than the second quantity, and the first attack degree being greater than the second attack degree.

In some aspects, the operation receiving module 1520 may be further configured to control, in response to the attack operation on the interactive element, the master virtual object to fire the prop filling element in the first prop accessory using the virtual prop to the interactive element; and perform, by the prop filling element in response to duration of the prop filling element remaining on the interactive element reaching preset duration, an explosion attack on the interactive element.

In some aspects, the prop transformation module 1540 may be further configured to display special effect prompt information, the special effect prompt information indicating that the functional prop attacks the interactive element after a preset duration threshold.

In some aspects, a distance between the master virtual object and the functional prop and a display effect of the special effect prompt information are in an inverse correlation.

In some aspects, the prop transformation module 1540 may be further configured to perform an explosion attack of a first attack degree on the interactive element based on the explosion attack performed by the functional prop in the virtual scene; and perform an accompanying attack of a second attack degree on the interactive element based on an explosion accompanying effect produced by the functional prop, attack damage of the first attack degree being greater than attack damage of the second attack degree.

In some aspects, the object display module 1510 may be further configured to display a skill selection interface, the skill selection interface including at least two candidate skills; and receive a selection operation on a target skill in the at least two candidate skills, the selection operation being configured for configuring the target skill for the virtual prop equipped by the master virtual object, and the target skill being configured for assisting the master virtual object to perform a prop function of the virtual prop.

In some aspects, the virtual prop may be implemented as a virtual firearm, and the first prop accessory may be implemented as a virtual magazine in the virtual firearm;
the operation receiving module 1520 may be further configured to control, in response to the attack operation on the interactive element, the master virtual object to perform a shooting attack on the interactive element using the virtual firearm, a virtual bullet in the virtual magazine being consumed in a process of the shooting attack; and
the prop transformation module 1540 may be further configured to control, in response to the virtual bullet in the virtual magazine being consumed completely, the master virtual object to switch the virtual magazine in the virtual firearm to another prop accessory.

In conclusion, after the first prop accessory may be switched to the second prop accessory, the switched first prop accessory may be transformed into the functional prop and assists the master virtual object to attack the interactive element, which avoids the waste of the first prop accessory after use, not only increasing the utilization of the first prop accessory, but also expanding the gameplay of the game and fully improving the interestingness of the game, thereby improving the efficiency of human-computer interaction.

The virtual object control apparatus provided in the foregoing aspect may be described only using the division of the foregoing functional modules as an example. In practice, the foregoing functions may be assigned to and completed by different functional modules as required. In other words, an internal structure of a device may be divided into different functional modules to complete all or some of the functions described above. In addition, the virtual object control apparatus provided in the foregoing aspect and the aspect of the virtual object control method belong to the same concept. For the specific implementation process, refer to the method aspects. Details are not described herein again.

FIG. 16 is a block diagram of a structure of an electronic device 1600 according to an illustrative aspect. The electronic device 1600 may be a portable mobile terminal, such as a smartphone, an on-board terminal, a tablet computer, a moving picture experts group audio layer III (MP3) player, a moving picture experts group audio layer IV (MP4) player, a notebook computer, or a desktop computer. The electronic device 1600 may also be referred to as another name such as user equipment, a portable terminal, a laptop terminal, or a desktop terminal.

Usually, the electronic device 1600 includes a processor 1601 and a memory 1602.

The processor 1601 may include one or more processing cores, for example, a 4-core processor or an 8-core processor.

The memory 1602 may include one or more computer-readable storage media. The computer-readable storage medium may be non-transient.

In some aspects, the electronic device 1600 may further include one or more sensors. The one or more sensors include, but are not limited to: a proximity sensor, a gyroscope sensor, and a pressure sensor.

In some aspects, the electronic device 1600 may further include another component. A person skilled in the art may understand that the structure shown in FIG. 16 constitutes no limitation on the electronic device 1600, and the electronic device may include more or fewer components than those shown in the figure, or some components may be combined, or a different component deployment may be used.

An aspect further provides a computer device. The computer device may be implemented as the terminal or the server shown in FIG. 2. The computer device includes a processor and a memory. The memory stores at least one instruction, at least one section of a program, and a code set or an instruction set. The at least one instruction, the at least one section of the program, and the code set or the instruction set are loaded and executed by the processor to implement the virtual object control method provided in the foregoing method aspects.

An aspect further provides a computer-readable storage medium. The computer-readable storage medium stores at least one instruction, at least one section of a program, and a code set or an instruction set. The at least one instruction, the at least one section of the program, and the code set or the instruction set are loaded and executed by a processor to implement the virtual object control method provided in the foregoing method aspects.

An aspect may further provide a computer program product or a computer program. The computer program product or the computer program may include computer instructions. The computer instructions may be stored in a computer-readable storage medium. A processor of a computer device may read the computer instructions from the computer-readable storage medium. The processor may execute the computer instructions to enable the computer device to perform the virtual object control method according to any one of the aspects.

In one aspect, the computer-readable storage medium may include a read-only memory (ROM), a random access memory (RAM), a solid-state drive (SSD), or an optical disc. The RAM may include a resistance random access memory (ReRAM) and a dynamic random access memory (DRAM). The sequence numbers of the foregoing aspects are merely for description, but do not indicate the preference among the aspects.

What is claimed is:

1. A virtual object control method, comprising:
displaying, by one or computing devices and via a virtual scene interface, a virtual scene comprising a master virtual object and an interactive element, wherein the master virtual object is equipped with a virtual prop, wherein the virtual prop comprises a first prop accessory, and wherein the first prop accessory comprises a plurality of prop filing elements;
controlling, based on receiving a first request for an attack operation on the interactive element, based on a consumption of one or more prop filling elements of the plurality of prop filing elements, and in the virtual scene, the master virtual object to perform the attack operation on the interactive element using the virtual prop;
controlling, based on receiving a second request for an accessory switching operation and in the virtual scene, the master virtual object to switch the first prop accessory of the virtual prop to a second prop accessory; and
displaying the first prop accessory being detached from the virtual prop; and
transforming, in the virtual scene, the first prop accessory into a functional prop accessory, wherein the functional prop accessory is configured for assisting the master virtual object to attack the interactive element.

2. The virtual object control method of claim 1, further comprising:
based on the functional prop accessory meeting a preset condition:
generating an explosion operation in the virtual scene; and
reducing an attribute value, of the interactive element, within a preset range.

3. The virtual object control method of claim 1, further comprising:
based on the functional prop accessory meeting a preset condition:
generating, in the virtual scene, a deceleration operation; and
reducing a movement speed, of the interactive element, within a preset range.

4. The virtual object control method of claim 1, wherein the controlling the master virtual object to switch from the first prop accessory of the virtual prop to the second prop accessory is further based on a consumption quantity of the one or more prop filling elements reaching a consumption threshold.

5. The virtual object control method of claim 4, wherein the consumption quantity indicates a complete consumption of the plurality of prop filing elements.

6. The virtual object control method of claim 1, further comprising:
after the transforming of the first prop accessory into the functional prop accessory, controlling, based on receiving a third request for a throwing operation, the master virtual object to perform the throwing operation to throw the virtual prop to a specified region.

7. The virtual object control method of claim 1, wherein the transforming the first prop accessory into the functional prop accessory further comprises:
in response to a quantity of the prop filling elements remaining in the first prop accessory being a first quantity, associating the functional prop accessory with a first attack power; or
in response to the quantity of the prop filling elements remaining in the first prop accessory being a second quantity, associating the functional prop accessory with a second attack power,
wherein the first quantity is greater than the second quantity; and
wherein the first attack power is greater than the second attack power.

8. The virtual object control method of claim 1, wherein the controlling the master virtual object to perform the attack operation on the interactive element further comprises:
controlling the master virtual object to fire the one or more prop filling elements in the first prop accessory towards the interactive element; and
generating, based on a duration of the one or more prop filling elements being on the interactive element reaching a preset duration and in the virtual scene, an explosion attack on the interactive element.

9. The virtual object control method of claim 1, further comprising:
after the transforming of the first prop accessory into the functional prop accessory, generating special effect prompt information, wherein the special effect prompt information indicates that the functional prop accessory performs another attack operation on the interactive element after a preset duration threshold.

10. The virtual object control method of claim 9, wherein a display effect of the special effect prompt information is based on a distance between the master virtual object and the functional prop accessory.

11. The virtual object control method of claim 1, further comprising:
performing an explosion operation of a first attack degree on the interactive element based on the functional prop accessory; and
performing another attack operation of a second attack degree on the interactive element wherein an attack damage of the first attack degree is greater than an attack damage of the second attack degree.

12. The virtual object control method of claim 1, further comprising:
before the displaying the virtual scene:
displaying a skill selection interface, wherein the skill selection interface comprises at least two candidate skills; and
receiving a selection operation on a target skill, from the at least two candidate skills, wherein the selection operation is configured to configure the target skill for the virtual prop.

13. The virtual object control method of claim 1, wherein the virtual prop is implemented as a virtual firearm, and the first prop accessory is implemented as a virtual magazine in the virtual firearm;
wherein the controlling the master virtual object to perform the attack operation on the interactive element comprises:
controlling the master virtual object to perform a shooting operation on the interactive element using the virtual firearm and based on a consumption of a virtual bullet in the virtual magazine; and
wherein the controlling the master virtual object to switch from the first prop accessory of the virtual prop to the second prop accessory comprises:
controlling, based on a consumption of the virtual bullet in the virtual magazine, the master virtual object to switch the virtual magazine in the virtual firearm to another virtual magazine.

14. A virtual object control apparatus, comprising:
one or more processors; and
memory storing instructions that, when executed by the one or more processors, cause the virtual object control apparatus to:
display, via a virtual scene interface, a virtual scene comprising a master virtual object and an interactive element, wherein the master virtual object is equipped with a virtual prop, wherein the virtual prop comprises a first prop accessory, and wherein the first prop accessory comprises a plurality of prop filing elements;
control, based on receiving a first request for an attack operation on the interactive element, based on a consumption of one or more prop filling elements of the plurality of prop filing elements, and in the virtual scene, the master virtual object to perform the attack operation on the interactive element using the virtual prop;
control, based on receiving a second request for an accessory switching operation and in the virtual scene, the master virtual object to switch the first prop accessory of the virtual prop to a second prop accessory; and
display the first prop accessory being detached from the virtual prop; and
transform, in the virtual scene, the first prop accessory into a functional prop accessory, wherein the functional prop accessory is configured for assisting the master virtual object to attack the interactive element.

15. The virtual object control apparatus of claim 14, wherein the instructions, when executed by the one or more processors, cause the virtual object control apparatus to:
based on the functional prop accessory meeting a preset condition:
generate an explosion operation; and
reduce an attribute value, of the interactive element, within a preset range.

16. The virtual object control apparatus of claim 14, wherein the instructions, when executed by the one or more processors, cause the virtual object control apparatus to:
based on the functional prop accessory meeting a preset condition:
generate a deceleration operation; and
reduce a movement speed, of the interactive element, within a preset range.

17. The virtual object control apparatus of claim 14, wherein the instructions, when executed by the one or more processors, cause the virtual object control apparatus to control the master virtual object to switch from the first prop accessory of the virtual prop to the second prop accessory further based on a consumption quantity of the one or more prop filling elements reaching a consumption threshold.

18. A non-transitory computer-readable storage medium, storing computer readable instructions that, when executed by a processor, cause a data processing system to perform:
displaying, via a virtual scene interface, a virtual scene comprising a master virtual object and an interactive element, wherein the master virtual object is equipped with a virtual prop, wherein the virtual prop comprises a first prop accessory, and wherein the first prop accessory comprises a plurality of prop filing elements;
controlling, based on receiving a first request for an attack operation on the interactive element, based on a consumption of one or more prop filling elements of the plurality of prop filing elements, and in the virtual scene, the master virtual object to perform the attack operation on the interactive element using the virtual prop;
controlling, based on receiving a second request for an accessory switching operation and in the virtual scene, the master virtual object to switch the first prop accessory of the virtual prop to a second prop accessory; and
displaying the first prop accessory being detached from the virtual prop; and
transforming, in the virtual scene, the first prop accessory into a functional prop accessory, wherein the functional prop accessory is configured for assisting the master virtual object to attack the interactive element.

19. The non-transitory computer-readable storage medium of claim 18, wherein the computer readable instructions that, when executed by the processor, cause the data processing system to perform:
based on the functional prop accessory meeting a preset condition:
generating an explosion operation; and
reducing an attribute value, of the interactive element, within a preset range.

20. The non-transitory computer-readable storage medium of claim 18, wherein the computer readable instructions that, when executed by the processor, cause the data processing system to perform:
based on the functional prop accessory meeting a preset condition:
generating a deceleration operation; and
reducing a movement speed. of the interactive element, within a preset range.
